(19) United States
(12) Patent Application Publication
(10) Pub. No.: US 2015/0329435 A1
(43) Pub. Date: Nov. 19, 2015

(54) COMBINED ANIMAL REPELLANT AND FERTILIZER COMPOSITION

(71) Applicant: Woodstream Corporation, Lititz, PA (US)

(72) Inventor: Brent HARDY, Lancaster, PA (US)

(21) Appl. No.: 14/711,268

(22) Filed: May 13, 2015

Related U.S. Application Data
(60) Provisional application No. 61/992,462, filed on May 13, 2014.

(51) Int. Cl. C05G 3/00; A01N 65/18; A01N 65/06; C05C 9/00; A01N 65/08; A01N 65/28; A01N 65/42; A01N 63/00; A01N 65/24

(52) U.S. Cl. CPC C05G 3/00; A01N 63/00; A01N 65/18; A01N 65/06; A01N 65/24; A01N 65/08; A01N 65/28; A01N 65/42; C05C 9/00

(57) ABSTRACT

A composition, as a liquid or spreadable solids, combines an effective amount of a fertilizer, preferably urea and potassium sulfate or potassium chloride, and an effective amount of an animal repellant, preferably a minimum-risk pesticide product, with a liquid carrier, preferably water, or a spreadable solid carrier.

This application claims priority of provisional U.S. application No. 61/992,462, filed May 13, 2014, the disclosure of which is incorporated herein by reference.

The present invention is generally directed to a composition containing combined animal repellant and fertilizer components and, more specifically, to a composition which can provide both animal repellancy and fertilizer capabilities for lawns, plants, gardens and the like, including domestic, home, and farm use.

While there are various fertilizer products on the market which include certain ingredients which may have animal repellant capability, there is no presently known product currently being marketed which is specifically formulated to provide both an effective animal repellant composition and an effective fertilizer composition in combination. Hence, there is a need for a composition which contains in combination an effective amount of an animal repellant component and an effective amount of a fertilizer component.

### DESCRIPTION OF INVENTION

As stated above, the present invention combines an animal repellant component and a fertilizer component in effective amounts for application to lawns, plants, gardens, etc. The animal repellant component should be selected from one or more of minimum risk pesticide products defined herein as selected from the products listed by section 25(b) of FIFRA (Federal Insecticide Fungicide Rodenticide Act) (hereinafter sometimes “25B List Actives” or simply “25B”). The 25B List Actives includes the following: castor oil (U.S.P. or equivalent), cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemongrass oil, linseed oil, malic acid, mint and mint oil, peppermint and peppermint oil, 2-phenethyl propionate (2-phenylethyl propionate), potassium sorbate, putrescent whole egg solids, rosemary and rosemary oil, sesame (includes ground sesame plant) and sesame oil, sodium chloride (common table salt), sodium lauryl sulfate, soybean oil, thyme and thyme oil, white pepper, and zinc metal strips (consisting solely of zinc metal and impurities).

The preferred animal repellant actives include the following: castor oil, cedar oil, cinnamon and cinnamon oil, citronella and citronella oil, cloves and clove oil, dried blood, garlic and garlic oil, geraniol, geranium oil, lemongrass oil, mint and mint oil, peppermint and peppermint oil, putrescent whole egg solids, rosemary and rosemary oil, sodium lauryl sulfate, thyme and thyme oil, and white pepper.

The fertilizer component for the present invention should be selected from one or more of the following fertilizers: dried blood, bone meal, fish oil, granite, gypsum, humic acid, humic-acid potassium salt, humic-acid sodium salt, iron magnesium oxide, iron oxide (Fe₂O₃ and FeO), cocoa shells, corn cob, corn gluten meal, corn steep liquor, cottonseed meal, dolomite, dried distillers grain, egg shells, fish meal, lime (chemically) dolomite, limestone, linseed meal, 1-lysine, magnesium carbonate, soybean flour, soybean hulls, soybean meal, sulfur, sunflower meal, urea, zinc iron oxide, zinc oxide, magnesium oxide, magnesium sulfate, magnesium sulfate heptahydrate, meat meal, molasses, oyster shells, potassium chloride, potassium humate, potassium sulfate, sawdust, seaweed/kelp, sodium humate, and sodium sulfate. The preferred fertilizer compounds are urea and potassium sulfate or potassium chloride.

The combined animal repellant and fertilizer composition of the present invention is preferably formulated as a sprayable, i.e., ready-to-use (RTU) liquid or liquid (dilutable) concentrate. The composition of the present invention is also preferably formulated as spreadable solids. As a sprayable liquid, the selected repellant and fertilizer components from those listed above should comprise less than approximately 4%-5% of the overall composition by weight, with the remaining approximately 95%-96% being the liquid carrier, preferably water, again by weight.

As a sprayable liquid concentrate, formulated to be applied after diluting with water, the selected repellant and fertilizer components from those listed above should comprise approximately 25%-50% of the overall composition by weight, with the remaining approximately 50%-75% being the liquid carrier, preferably water, again by weight.

In the spreadable solids formulation, the selected repellant and fertilizer components from those listed above can comprise 10% or more of the overall composition by weight, even up to 100%. However, the composition preferably includes a carrier of approximately 85%-99%, by weight, such as Fuller's Earth (calcium montmorillonite) and EcoGranule, a commercially available granular carrier made up of granite, sawdust and corn starch. More preferably, the inert component should be about 89%-90% by weight. All percentages for ingredients set forth herein are by weight based on the weight of the total composition (w/w).

The sprayable liquid and liquid concentrate formulations of the invention are designed for foliar application, i.e., applied in liquid form directly to the foliage (leaves and stems) of the target plant. The fertilizer nutrients are absorbed primarily through the stomata of the leaf, but they are also absorbed through the epidermis/cuticle. The absorption is rapid through the foliage, which provides quick access to the nutrients applied. Because the nutrients are absorbed directly into the plant (as opposed to through the soil), they are ideally in a form that is readily available to the plant, which has led the inventors to use in the invention composition urea as the most preferred source of nitrogen and one or both of potassium sulfate and potassium chloride as the most preferred source of potassium. The challenge (i.e., problem) solved by the inventors is to provide enough of these nutrients, but not too much, as an excess can cause injury to the plant including leaf burn.

The spreadable solids formulation of the invention is designed to be applied to the ground, as opposed to the plant foliage directly. The spreadable solids formulation can be in any non-liquid form such as, e.g., loose powder, granular, and palletized. Higher percentages of fertilizer can be used in the spreadable solids formulation, compared to those used in the liquid sprayable formulations, because the nutrients are applied to the soil using the spreadable solids formulation, and not to the plant directly. A number of steps must occur (in the soil) before the nutrients are taken up by the plant, and other factors such as leaching, chemical reactions, microbial activity can reduce the amount of nutrients ultimately taken up by the plant.

In order to make the sprayable formulation of the present invention, the liquid diluent(s), preferably water, are first thoroughly mixed until uniform. The other components (excepting the pH modifier(s)), both solid and liquid, i.e., the selected animal repellant(s) and fertilizer(s) together with any optional ingredients, e.g., preservative(s) (such as, e.g., potassium sorbate and sodium benzoate), and “sticker(s)” (described below) are then added to the diluent(s) and mixed until uniform. The final step is to adjust the pH, if necessary, by adding a pH modifier such as, e.g., citric acid (preferred) at an amount of 0.01%-3.0%, one or both of vinegar in an amount of 0.01%-5.0% and acetic acid at an amount of 0.01%-3.0%, and any other material allowed by the 25B requirements having pH modifying properties. Preferably, the pH of the resulting sprayable composition is adjusted to an optimum pH range of about 3.0 to about 7, more preferably to an optimum pH of about 4.5. The order of addition of ingredients should be organized so that the formulation combines in the most optimal way, which is known to those skilled in the art. This order will be different based on ingredients used and material properties.

The solid components can be added in several steps if helpful to ingredient dissolution or overall product properties (viscosity, emulsion, etc.). One instance of this would be to premix xanthan gum with other powder materials in the formula to better facilitate wetting out of the gum. This premix would be added to the diluent liquid first and completely wetted out before adding to the diluent the remaining solid components.

Spreadable solids formulations of the invention optionally include one or more of citric acid in an amount of 0.01%-3.0%, vinegar in an amount of 0.01%-5.0%, acetic acid in an amount of 0.01%-3.0%, and other material allowed by the 25B requirements having ph modifying properties If multiple liquid diluents are used, they should be mixed together until uniform before they are added to the solid components.

“Stickers” are known materials that help adhere the active ingredients sprayed onto the plant in order to extend product efficacy and provide rain resistance. Materials useful as stickers are also useful as viscosity modifiers, suspension aids, and emulsifiers. In liquid formulations of the invention the preferred sticker is xanthan gum, more preferably in an amount of 0.01%-1.0%. Other useful stickers include one or more of animal glue or glues, depolymd. (depolymerized animal glue) (cas #68476-37-9) in an amount of 0.01%-11.0%, oils having sticker properties such as, e.g., castor oil, fish oil, cottonseed oil, rapeseed oil, soybean oil, linseed oil, mineral oil (u.s.p.), canola oil, wheat germ oil, wintergreen oil, white mineral oil (petroleum), and palm oil, in an amount of 0.05%-97.0%, gums such as, e.g., agar, guar gum, carob, gellan, gum arabic, gum tragacanth, carrageenan, carboxymethyl cellulose, and xanthan gum, in an amount of 0.01%-4.0%, or any other material that has sticker properties and is allowed by the 25B requirements.

Preservatives provide resistance against microbial growth (bacterial, mold, fungus, yeast, etc). In liquid formulations the preferred preservative is one or both of potassium sorbate and sodium benzoate at a total preservative amount of 0.01%-2.0%. Other useful preservatives include any material allowed by the 25B requirements having preservative properties. (The same preservatives described above, in the same amounts, are useful in the spreadable solids formulation of the invention.)

If the formulation contains oil(s), and the diluent/carrier is water or a hydrophilic material, the oil is added after, or in combination with, adding a surfactant. Similarly if the diluent is an oil or hydrophobic material, any water based ingredients should be added after, or in combination with, a surfactant.

It is typical to add a surfactant to a foliar fertilizer in order to better facilitate adsorption by decreasing surface tension. Surfactants also facilitate mixing of oil and water components. The most preferred surfactant in liquid formulations is sodium lauryl sulfate in an amount of about 0.01%-2.5%. Other surfactants useful are one or more of lecithins and soya lecithins in an amount of about 0.01%-15.0%, soaps such as, e.g., the water soluble sodium and potassium salts of fatty acids produced by either the saponification of fats and oils or the neutralization of fatty acids, in an amount of about 0.01%-5.0%, and any other material having surfactant properties and allowed by the 25B requirements.

For spreadable solids formulations, surfactants help absorb the liquid portion into, and then release from when used, the dry carriers. The same surfactants, in the same amounts, that are useful in the liquid formulations (as described above) are also useful in the solids spreadable formulations.

The composition of the present invention in spreadable solids form comprises liquid-coated, or liquid-soaked, inert carrier granules (e.g., Fuller's Earth) in combination with the dry, preferably powdered, components described above. The carrier, or multiple carriers thoroughly mixed, granules are thoroughly mixed with the liquid ingredients until the liquid(s) uniformly coat, or are absorbed by, the carrier granules. This can be done one liquid ingredient at a time or by premixing the liquid ingredients and then adding the liquid premix to the carrier granules. The premix of liquids can preferably contain useful ingredients such as surfactant(s), preservative(s), antioxidant(s), pH modifier(s), viscosity modifier(s), emulsifier(s), etc., well known in the art. This can be helpful if one of the liquid ingredients is a binder (which binds the dry components to the carrier granules), such as, e.g., one or more of animal glue or glue (depolymd. animal collagen) (cas #68476-37-9) in an amount of 0.01%-11.0%, oils having binding properties such as, e.g., castor oil, fish oil, cottonseed oil, rapeseed oil, soybean oil, linseed oil, mineral oil (u.s.p.), canola oil, wheat germ oil, wintergreen oil, white mineral oil (petroleum), and palm oil, in an amount of 0.05%-97.0%, gums such as, e.g., agar, guar gum, carob, gellan, gum arabic, gum tragacanth, carrageenan, carboxymethyl cellulose, and xanthan gum, in an amount of 0.01%-4.0%, 0.01%-4.0%, lard in an amount of 0.01%-20%, and any other material that has binder properties and is allowed by the 25B requirements.

Preferably, the liquid ingredients are premixed and the premix is then sprayed through a nozzle onto the carrier granules while the granules are being agitated, to ensure that the liquid ingredients are evenly distributed. These liquid-coated or liquid-soaked carrier granules are spreadable as is, or they can be pelletized or pulverized, if desired, as known to those skilled in the art.

The combined animal repellant and fertilizer composition of the present invention is intended to repel animals of various species including, but not limited to, armadillo, beaver, birds, cat, chipmunks, coyote, deer, dog, fox, groundhogs, mice, mink, moles, muskrat, opossums, porcupine, rabbit, raccoon, rats, rodents, shrew, skunks, snakes, squirrel, vole, and weasel.

A preferred multi-species repellant component, of the repellant-fertilizer composition of the invention, contains the following actives in amounts (%) by weight based on the total weight of the composition:
Blood meal: 0.001%-50.0%
Castor Oil: 0.0001%-10.0%
Cedar Oil: 0.0001%-3.5%
Cinnamon Oil: 0.0001%-2.5%
Citronella Oil: 0.0001%-2.5%
Clove Oil: 0.0001%-2.5%
Putrescent Whole Egg Solids: 0.0001%-37%
Garlic: 0.0001%-5%
Sodium Lauryl Sulfate: 0.001%-2.5%
White Pepper: 0.0001%-2.5%

Other preferred multi-species repellant components constitute one or more of the following, at a total repellant component amount of 0.0001%-99.9%:
Castor oil (U.S.P. or equivalent)
Cedar oil
Cinnamon and cinnamon oil
Citric acid
Citronella and Citronella oil
Cloves and clove oil
Corn gluten meal
Corn oil
Cottonseed oil
Dried Blood
Eugenol
Garlic and garlic oil
Geraniol
Geranium oil
Lauryl sulfate
Lemongrass oil
Linseed oil
Malic acid
Mint and mint oil
Peppermint and peppermint oil
2-Phenethyl propionate (2-phenylethyl propionate)
Potassium sorbate
Putrescent whole egg solids
Rosemary and rosemary oil
Sesame (includes ground sesame plant) and sesame oil
Sodium chloride (common salt)
Sodium lauryl sulfate
Soybean oil
Thyme and thyme oil
White pepper
Zinc metal strips (consisting solely of zinc metal and impurities).

A preferred deer and rabbit repellant component, of the repellant-fertilizer composition of the invention, contains the following actives in amounts (%) by weight based on the total weight of the composition:
Putrescent Whole Egg Solids: 0.0001%-37%
Garlic: 0.0001%-5%
Sodium Lauryl Sulfate: 0.001%-2.5%
Other ingredients include any of the following individually or in combination with one another in a total amount of 0.0001%-99.9%
Castor oil (U.S.P. or equivalent)
Cedar oil
Cinnamon and cinnamon oil
Citric acid
Citronella and Citronella oil
Cloves and clove oil
Corn gluten meal
Corn oil
Cottonseed oil
Dried Blood
Eugenol
Garlic and garlic oil
Geraniol
Geranium oil
Lauryl sulfate
Lemongrass oil
Linseed oil
Malic acid
Mint and mint oil
Peppermint and peppermint oil
2-Phenethyl propionate (2-phenylethyl propionate)
Potassium sorbate
Putrescent whole egg solids
Rosemary and rosemary oil
Sesame (includes ground sesame plant) and sesame oil
Sodium chloride (common salt)
Sodium lauryl sulfate
Soybean oil
Thyme and thyme oil
White pepper
Zinc metal strips (consisting solely of zinc metal and impurities).

Antioxidants are useful optional ingredients in the composition of the invention. Useful antioxidants include, but are not limited to, e.g., one or more of vitamin E, rosemary, ethoxyquin, and any material allowed by the 25B requirements having antioxidant properties, at a total antioxidant amount of 0.001%-2.0%.

The preferred diluent/carrier in liquid formulations of the invention is water in an amount of 0.01%-99.9%. Other useful carriers/diluents, at a total amount of 0.01%-99.9%, include but are not limited to one or more of castor oil, fish oil, cottonseed oil, rapeseed oil, soybean oil, linseed oil, mineral oil (U.S.P.), canola oil, wheat germ oil, wintergreen oil, white mineral oil (petroleum), and palm oil, along with any material allowed by the 25B requirements having diluent/carrier properties.

The preferred inert carrier of the solids formulation contains a combination of granite, sawdust, and starch at a total amount of 50.0%-99.0%. Other useful inert carriers, at an amount of 0.01%-99.9%, include but are not limited to almond hulls, almond shells, bran, calcium carbonate, citrus meal, corn cob, cottonseed meal, cracked wheat, diatomaceous earth (less than 1% crystalline silica), dolomite, fish meal, fuller's earth, granite, dolomitic lime (chemical), limestone, linseed meal, meat meal, mica, mica-group minerals, millet seed, peanut hulls, peanut shells, perlite, perlite, expanded, sawdust, soybean flour, soybean hulls, sunflower meal, vermiculite, walnut flour, walnut shells, wheat, wheat flour, wool, zeolites, and any other material allowed by the 25B requirements with carrier properties.

The most preferred fertilizer in liquid formulations is a combination of urea at an amount of 0.01%-55% and potassium sulfate at an amount of 0.01%-40%. Other preferred fertilizers, at a total amount of 0.01%-99.9%, include but are not limited to egg shells, molasses, cocoa shells, alfalfa meal, soybean meal, brewer's yeast, fish meal, blood meal, 1-lysine, urea, cottonseed meal, bone meal, sawdust, seaweed/kelp, fish oil, meat meal, corn steep liquor, corn gluten meal, calcite, calcium carbonate, calcium sulfate, canola meal, clam shells, corn cob, dolomite, dried distillers grain, granite, gypsum, humic acid, humic-acid potassium salt, humic-acid sodium salt, iron magnesium oxide, iron oxide (Fe₂O₃), iron oxide (FeO), lime (chemical) dolomitic, limestone, linseed meal, magnesium carbonate, magnesium oxide, magnesium sulfate, magnesium sulfate heptahydrate, oyster shells, potassium chloride, potassium humate, potassium sulfate, sodium humate, sodium sulfate, soybean flour, soybean hulls, sulfur, sunflower meal, zinc iron oxide, zinc oxide, and any other material allowed by the 25B requirements with fertilizer properties.

The most preferred fertilizer in spreadable solids formulations is a combination of urea at an amount of 0.01%-55% and potassium sulfate at an amount of 0.01%-40%. Other preferred fertilizers, at a total amount of 0.01%-99.9%, include but are not limited to egg shells, molasses, cocoa shells, alfalfa meal, soybean meal, brewer's yeast, fish meal, blood meal, 1-lysine, urea, cottonseed meal, bone meal, sawdust, seaweed/kelp, fish oil, meat meal, corn steep liquor, corn gluten meal, calcite, calcium carbonate, calcium sulfate, canola meal, clam shells, corn cob, dolomite, dried distillers grain, granite, gypsum, humic acid, humic-acid potassium salt, humic-acid sodium salt, iron magnesium oxide, iron oxide (Fe₂O₂), iron oxide (FeO), lime (chemical) dolomitic, limestone, linseed meal, magnesium carbonate, magnesium oxide, magnesium sulfate, magnesium sulfate heptahydrate, oyster shells, potassium chloride, potassium humate, potassium sulfate, sodium humate, sodium sulfate, soybean flour, soybean hulls, sulfur, sunflower meal, zinc iron oxide, zinc oxide, and any other material allowed by the 25B requirements with fertilizer properties.

The preferred NPK ranges (%) in liquid RTU formulations are
N 0.001-2.5
P 0.000-4.5
K 0.001-1.5

The preferred NPK ranges (%) in liquid concentrate formulations are
N 0.05-32
P 0.00-42
K 0.05-20

The preferred NPK ranges (%) in spreadable solids formulations are
N 0.01-35
P 0.00-27
K 0.01-8
   The most preferred nutrient (NPK) specific materials are
N—Urea
P—none, target 0%
K—Potassium Sulfate

Other NPK specific materials include, but are not limited to
N—Blood meal, Fish Meal, Corn Gluten Meal, Soybean Meal, Brewer's Yeast, L-Lysine
P—Bone meal, Meat Meal, Fish Meal, Cottonseed Meal, Brewer's Yeast
K—Potassium Chloride, Kelp Meal, Molasses, Cocoa Shells, Brewer's Yeast

Preferred optional micro-nutrients include
Calcium—Lime (chemical) dolomitic, Limestone, Calcium Carbonate, Gypsum, Calcium Sulfate, Clam Shells, Oyster Shells
Magnesium—Magnesium Oxide, Magnesium Sulfate, Dolomite, Lime (chemical) dolomitic
Sulfur—Sulfur, Magnesium Sulfate, Calcium Sulfate, Potassium Sulfate, Sodium Sulfate, Gypsum
Zn—Zinc Oxide, Zinc Iron Oxide
Fe—Iron oxide (Fe₂O₃), Iron Oxide (FeO), Iron Magnesium Oxide
Other (trace nutrients, hormones, etc.)—Seaweed, Kelp, Humates/Humic acid, Fish Oil

### SPECIFIC EXAMPLES

The following examples exemplify the combined animal repellant and fertilizer composition of the present invention. All percentages in the following examples and claims are based upon the weight of the component versus the total weight of the composition (w/w), unless otherwise indicated.

### Example 1

### Multi-Species Ready-to-Use Sprayable Liquid (NPK: 0.4-0-0.1)

### Active Animal Repellant Components

| | |
|---|---|
| Dried Blood | 0.050% |
| Castor oil | 1.000% |
| (U.S.P. or equivalent) | |
| Cedar oil | 0.100% |
| Cinnamon | 0.100% |
| Citronella | 0.100% |
| Cloves | 0.100% |
| Putrescent whole egg solids | 0.050% |
| Garlic | 0.010% |
| Sodium lauryl sulfate | 0.200% |
| White pepper | 0.025% |

### Active Fertilizer components

| | |
|---|---|
| Potaasium Sulfate | 0.086% |
| Urea | 0.650% |

### Inerts

| | |
|---|---|
| Citric acid | 0.230% |
| Potassium sorbate | 0.200% |
| Sodium benzoate | 0.200% |
| Xanthan gum | 0.200% |

Mix all above dry components, except citric acid, with water, 96.699% w/w, until complete dissolution is reached. Then add the sodium lauryl sulfate, followed by the above liquid components, and mix to achieve adequate suspension. Finally adjust pH by adding the citric acid.

### Example 2

### Multi-Species Granular Composition (NPK: 4.0-0-1.0)

### Active Animal Repellant Components

| | |
|---|---|
| Dried Blood | 0.050% |
| Castor oil | 1.000% |
| (U.S.P. or equivalent) | |
| Cedar oil | 0.100% |
| Cinnamon | 0.100% |
| Citronella | 0.100% |
| Cloves | 0.100% |
| Putrescent whole egg solids | 0.050% |
| Garlic | 0.010% |
| White pepper | 0.025% |

### Active Fertilizer Components

| | |
|---|---|
| Potassium Sulfate | 0.900% |
| Urea | 6.520% |

### Inert Carrier

| | |
|---|---|
| Fuller's Earth | 89.245% |

The above dry components are thoroughly mixed together, including the Fuller's Earth, 89.945% w/w, as the inert carrier, to form a dry mixture. The above liquid components are then applied to the dry mixture until uniformly absorbed/coated.

### Example 3

### Ready-to-Use Sprayable Liquid Composition for Deer and Rabbits (NPK: 0.4-0-0.1)

### Active Animal Repellant Components

| | |
|---|---|
| Putrescent whole egg solids | 1.10% |
| Garlic | 0.40% |
| Sodium lauryl sulfate | 0.01% |

### Active Fertilizer Components

| | |
|---|---|
| Potassium Sulfate | 0.09% |
| Urea | 0.45% |

### Inerts

| | |
|---|---|
| Citric acid | 0.25% |
| Potassium sorbate | 0.20% |
| Sodium benzoate | 0.20% |
| Xanthan gum | 0.10% |

Mix all dry components, except citric acid, with water, 97.20% w/w, until complete dissolution is reached. Then add the sodium lauryl sulfate and mix to achieve adequate suspension. Finally adjust pH by adding the citric acid.

### Example 4

### Multi-Species Ready-to-Spray (RTS) Liquid Concentrate (4.0-0-1.0)

The following components are used to prepare 2 separate premix batches, which are then combined into a final batch mix, as detailed below.

### Active Animal Repellant Components

| | |
|---|---|
| Dried Blood | 0.50% |
| Castor Oil | 10.00% |
| Cedarwood Oil | 1.00% |
| Cinnamon Oil | 1.00% |
| Citronella Oil | 1.00% |
| Clove Oil | 1.00% |
| Putrescent Whole Egg Powder | 0.50% |
| Garlic | 0.10% |
| Sodium Lauryl Sulfate | 2.00% |
| White Pepper | 0.25% |

### Active Fertilizer Components

| | |
|---|---|
| Potassium Sulfate | 1.70% |
| Urea | 8.40% |

### Inert Components

| | |
|---|---|
| Citric Acid | 0.50% |
| Potassium Sorbate | 0.20% |
| Sodium Benzoate | 0.20% |
| Xanthan gum (Jungbunzlauer Food Grade) | 0.50% |
| Water | 71.15% |

Premix 1 is prepared by first mixing completely in a clean stainless steel tank equipped with a paddle mixer the castor oil, cedarwood oil (preheated and stirred to dissolve solids, if necessary), cinnamon leaf oil, citronella oil, and clove oil. After this first complete mixing, the xanthan gum is added to the mix with continued mixing until the mix is completely solubilized with no apparent clumps.

Premix 2 is prepared by first adding half the batch amount of water to a clean stainless steel tank equipped with a shear mixer, and then adding to the water in the tank, under continuous shear mixing until fully dissolved, the sodium benzoate, potassium sorbate, potassium sulfate, and urea. Then, slowly add to the mix, under high speed shear mixing, the solid active components dried blood, egg powder, garlic, and white pepper, with continued high speed mixing until mix contains no apparent clumps. Then, add to the mix, after slowing down the mixing speed to minimize foaming, the sodium lauryl sulfate (preheated to liquid form) until it is fully dissolved in the mix.

The final mix is prepared by first adding the remaining (half the batch amount of) water to a clean stainless steel tank equipped with a paddle mixer and then adding to the water in the tank, under paddle mixing, Premix 1 with continued mixing until homogeneity (at least 15 minutes), then, while still mixing, Premix 2 is added to the tank mix, mixing is continued until homogeneity (at least 15 minutes), and then the citric acid (as acidifying agent) is added to the mix with continued mixing until homogeneity (at least 30 minutes), to obtain the final (i.e., sprayable liquid) mix, having the following properties.

### Final-Mix/Sprayable-Liquid Properties

| Appearance | Thick, brown stable suspension |
|---|---|
| Specific Gravity | 1.02 ± 0.05 g/ml |
| pH (25° C.) | 4.50 ± 0.4 |
| Fragrance | Strong, spicy mix of cinnamon |
| | citronella, clove and cedar |
| NPK (% w/w) | 4-0-1 |

The sprayable liquid concentrate composition is packaged in, e.g., 16-48 ounce, preferably 32 ounce, high density polyethylene (H.D.P.E.) bottles capped with hose-end sprayers.

### Example 5

A multi-species granular composition is prepared as in Example 2 but with EcoGranule used as the inert carrier instead of Fuller's Earth and with changes in the component and carrier amounts as follows.

| | |
|---|---|
| Potassium Sulfate | 0.200% |
| EcoGranule | 89.945% |

### Example 6

A multi-species ready-to-use sprayable liquid is prepared as in Example 1 with changes in the component and carrier amounts as follows.

| | |
|---|---|
| Sodium lauryl sulfate | 0.100% |
| Potassium Sulfate | 0.100% |
| Sodium benzoate | 0.100% |
| Water | 96.835% |

Claimed is:

1. A composition comprising, as a liquid or spreadable solids,
a) an active component containing an effective amount of a fertilizer and an effective amount of an animal repellant and
b) a carrier selected from the group consisting of
i) a liquid and
ii) a spreadable solid.

2. The composition of claim 1, wherein the amount of fertilizer is about 0.005-50% w/w, and wherein the amount of animal repellant is about 0.005-50% w/w.

3. The composition of claim 2, wherein the carrier is water, wherein the amount of fertilizer is about 0.05-20% w/w, and wherein the amount of animal repellant is about 0.05-20% w/w.

4. The composition of claim 3, wherein the water is present in an amount of about 80-99.55% w/w.

5. The composition of claim 4, wherein the effective amount of an animal repellant includes the following components:

| | |
|---|---|
| one or more of blood meal | 0.001%-50.0% |
| or dried blood | |
| castor oil | 0.0001%-10.0% |
| one or more essential oils | 0.0001%-11.0% |
| putrescent whole egg solids | 0.0001%-37.0% |
| garlic | 0.0001%-5.00% |
| white pepper | 0.0001%-2.50% |

and the effective amount of a fertilizer includes the following components:

| | |
|---|---|
| urea | 0.01%-55.0% |
| potassium sulfate | 0.01%-40.0% |

all of the above percentage amounts are based upon the total weight of the composition;
said composition also including an effective amount of a surfactant selected from the group consisting of sodium lauryl sulfate, a lecithin, a soya lecithin and a soap or combinations thereof; one or more stickers in an effective amount; and one or more of a preservative and an antioxidant in an effective amount.

6. The composition of claim 5, wherein the essential oil is selected from the group consisting of cedar oil, cinnamon oil, citronella oil and clove oil, or a combination thereof, the surfactant is sodium lauryl sulfate in an amount of about 0.01% to about 2.5%, and the sticker is xanthan gum in an amount of about 0.01% to about 1.0%.

7. The composition of claim 2, wherein the carrier is a spreadable solid selected from the group consisting of a powder, granules, and pellets.

8. The composition of claim 2, wherein the animal repellant contains at least one of dried blood and whole egg solids.

9. The composition of claim 2, wherein the animal repellant contains at least one of dried blood and whole egg solids, and wherein the fertilizer contains at least one of urea, potassium sulfate, and potassium chloride.

10. The composition of claim 2, further comprising a surfactant in an amount of about 0.01-15% w/w.

11. The composition of claim 10, wherein the surfactant is selected from the group consisting of sodium lauryl sulfate, a lecithin, a soya lecithin, a soap, and combinations thereof.

12. A method of making the composition of claim 1 comprising the steps of
mixing until uniform in a liquid carrier the effective amount of fertilizer and the effective amount of animal repellant to effect a liquid formulation and
adjusting to a pH of about 3.0-7 the liquid formulation.

13. The method of claim 12, wherein the amount of fertilizer is about 0.005-50% w/w, and wherein the amount of animal repellant is about 0.005-50% w/w.

14. The method of claim 13, wherein the liquid carrier is water, wherein the amount of fertilizer is about 0.05-20% w/w, and wherein the amount of animal repellant is about 0.05-20% w/w.

15. The method of claim 14, wherein the water is present in an amount of about 80-99.55% w/w.

16. A method of making the composition of claim 1 comprising the steps of
mixing together the fertilizer in an amount of about 0.005-50% w/w and the animal repellant in an amount of about 0.005-50% w/w to effect an active component premix and
applying the active component premix to a spreadable solid carrier.

17. The method of claim 16, wherein the spreadable solid carrier is selected from the group consisting of a powder, granules, and pellets, wherein the amount of fertilizer is about 0.05-20% w/w, and wherein the amount of animal repellant is about 0.05-20% w/w.

18. The method of claim 17, wherein the animal repellant contains at least one of dried blood and whole egg solids.

19. The method of claim 17, wherein the animal repellant contains at least one of dried blood and whole egg solids, and wherein the fertilizer contains at least one of urea, potassium sulfate, and potassium chloride.

20. A method of using the composition of claim 1 wherein the carrier is water comprising spraying the composition on vegetation in an amount sufficient to fertilize the vegetation and to repel animals therefrom.

21. A method of using the composition of claim 1 wherein the carrier is a spreadable solid selected from the group consisting of a powder, granules, and pellets comprising spreading the composition on vegetation-bearing ground in an amount sufficient to fertilize the vegetation and to repel animals therefrom.

22. A packaged product comprising
a) a container capped with a hose-end sprayer and holding
b) the composition of claim 3.

23. A ready-to-spray concentrate composition combining animal repellant and fertilizer components, which comprises:
a) an active animal repellant component containing in the following weight percentages:

| | |
|---|---|
| dried blood | 0.50% |
| castor oil | 10.00% |
| cedar oil | 1.00% |
| cinnamon oil | 1.00% |
| citronella oil | 1.00% |
| clove oil | 1.00% |
| putrescent whole egg powder | 0.50% |
| garlic | 0.10% |
| sodium lauryl sulfate | 2.00% |
| white pepper | 0.25% |

b) an active fertilizer component containing in the following weight percentages:

| | |
|---|---|
| potassium sulfate | 1.70% |
| urea | 8.40% |

and inert components in the following percentages:

| | |
|---|---|
| citric acid | 0.50% |
| potassium sorbate | 0.20% |
| sodium benzoate | 0.20% |
| xanthan gum | 0.50% |
| water | 71.15% |

all of the above percentages are approximate and are based upon the total weight of the concentrate composition.
